(19) United States
(12) Patent Application Publication
(10) Pub. No.: US 2010/0179957 A1
(43) Pub. Date: Jul. 15, 2010

(54) Polling Method of Switch Status Based on Timer-triggered Scheduler of Stored Procedures

(75) Inventors: JUNHUA ZHOU, Nanjing (CN); HAIHUA SONG, Nanjing (CN); LIBIN SUN, Nanjing (CN); XIWEI HUANG, Nanjing (CN); GUOXIANG LIU, Nanjing (CN)

Correspondence Address: GLOBAL IP SERVICES, 7285 W. Eagle Court, Winton, CA, 95388, US

(73) Assignee: LINKAGE TECHNOLOGY GROUP CO., LTD., Nanjing (CN)

(21) Appl. No.: 12/645,048

(22) Filed: Dec. 22, 2009

(30) Foreign Application Priority Data
Jan. 9, 2009 (CN) 200910028102.3

(51) Int. Cl. G06F 17/30

(52) U.S. Cl. 707/754; 707/E17.044

(57) ABSTRACT

The polling method of switch status based on Timer-triggered Scheduler of Stored Procedures is to create interface tables related with switch status in the database including switch object table, switch type table, alarms information table which are used to store meta-information and switch status values. Then, create stored procedure of acquiring relevant switch status for each kind of switch needed for polling of switch status, and data will be filtered out and switch status will be judged via the related stored procedures, and write the status values into relevant switch status interface table; finally create regularly-executed tasks to regularly schedule each stored procedure required to poll switch status. The whole process is composed of three parts: i.e., create relevant switch status interface table; create stored procedure of acquiring switch status and setting status value; regularly-executed tasks.

### CROSS REFERENCE TO RELATED PATENT APPLICATIONS

This application claims the priority of the Chinese patent application No. 200910028102.3 filed on Sep. 1, 2009, which application is incorporated herein by reference.

### FIELD OF THE INVENTION

This invention is a polling method of switch status which involved in the application monitoring system.

### BACKGROUND OF THE INVENTION

In an application monitoring system, there exists a timely monitoring measure which monitors the work status of all hosts, processes and flow switches distributed in various areas. So it is necessary to adopt a method which will query all switches' working status every few intervals as set. This method is called polling method of switch statues.

At present, there are three kinds of polling methods for monitoring switch statue. One is query application unified managed by monitoring system. Another is query application managed by every function modules of monitoring system. The last one is query application managed by the users of monitoring system after log in.

The first method is a unified scheduling by the monitoring system which should run in the application server. The shortage of this method is that it will take up the application server's memory and CPU resources.

The second method is running through the functional modules in the monitoring system. The shortage of this method is that the functional modules would repeatedly use the same application to query switch status. For example, the switch status of host module needs to query the process status firstly, while the switch status of process module also needs to query the process status firstly to determine status of the flow. So it will cause additional query operation workload of switch status which costs additional application system server resources.

The third method is to schedule by each user. During each enquiry interval, a great number of users will be rushed with a considerable number of query operations for switch status. If the user numbers of logging on the system is 100 or more, polling intervals of a specific period of time can be 100 times or more. The shortage of this method will cause additional workload of switch status query operations and also waste system resources.

For these three methods, query procedures of switch status finished being compiled need to be published in the application server which will occupy the system resources. What's more, when the query rule or process of switch status changes, the inquiry procedures need to be amended, and to be re-compiled and to be republished to the application server. However, in order to make the modified query procedure effective immediately, application server needs to be restarted which is not conducive to the maintenance and expansion of the system.

### SUMMARY OF THE INVENTION

### 1) Objective

The main objective of this invention is to invent an advanced polling method of switch status based on the stored procedure scheduling which solves the problems of inefficiency, maintenance and extension difficulties the new invention develops a new network state polling method without occupying system resources in application servers and avoids the duplication of switch status query operation. When the query rules change, it can be effective immediately without re-release into the system and also it makes full use of database server resources.

### 2) Technology Solution

Polling method of switch status based on the stored procedure scheduling is to create in the database the switches relevant switch interface table including object tables, the type of switch information table and the alarm table for storing information and switch state value, then create the stored procedure for various types of switches to obtain the corresponding switch status, filter out the data and determine the status of switches by the stored procedure and then input status value into switch status interface table. Finally, it needs to establish regular scheduling tasks for regular polling enquiry of each stored procedure.

The complete technical solution has three sections: create interface table related to switch status, access switch status and set the stored procedure for the state value and timer-triggered scheduling stored procedure regularly by the tasks:

Create Interface Table Related to Switch Status

Interface table for switch status is a set of tables in the database to establish the state of switches and storage-related data tables for storing switch status information, including switch object table, switch type table and alarm information table.
Switch object table: use to store basic switch information and status information, and its main fields include “switch object code”, “area code”, “switch object name”, “switch type code”, “father switch ID “, “the state of switch alarms” and “the working state of switch”.
Switch type tables: use to store the type of information to distinguish between various switch types in object table, and its main fields include “switch type code”, “switch type name” and “their process ID of switch part”.
Alarm information table: use to store all switch alarm information in the table, and its main fields include “switch ID”, “switch type code”, “fault-type number”, “alarm details”, “ alarm canceller” and “alarm cancellation time”.

Create switch object table, switch type table and alert network information table in the database. And basic information and related alarm information can be indexed by switch ID field, and the switch type can be indexed by switch type/number to distinguish whether switch belongs to host process or process type.

Access Switch Status and Set the Stored Procedure of the State Value

The function is to be realized through a group of SQL statements programmed to access switch status and finish the storage function of its state value and through controlling the implementation of these SQL statements and then making judgment logically. These stored procedures can be stored in the database after being compiled. Users can specify the name of stored procedure and then once parameters are given, the procedure is to be implemented, compiling only needed while creating a stored procedures, after the creation, no need any more for the compiling and commonly used method to access to switch status is to go to run the enquiry process in the server through implementing each SQL statement, every execution of a SQL statement needs to be compiled every time, so the use of stored procedures can improve efficiently in the implementation of SQL statements. What's more, stored procedure can be re-used which can help to reduce the development workload.

For the present invention method, switch status' (including the process of switch status and the host switch state) access and value setting needs complex data operations such as data query, logical judgments, data records amendment and so on.

So it will improve the implementation speed of the process if those operations are encapsulated. The main stored procedure is to access to the process of stored procedure's switch status and host's switch status.

1) Access to the Stored Process of Switch Status

To obtain the status of switch type, the main steps are as below:
a) Create a database cursor and filter out the application type switch record from network object table.
b) Start to cycle of the cursor records.
c) Initialize parameters.
d) from alarm record table, calculate the number of the records with un-recovered status, and those records which the switch ID is equal to that of the current cursor record.
e) Determine whether the total number of alarm records is zero. If it is zero, set the alarm state with the non-alarm,
f) or else set the alarm status with alarm.
g) Continue to cycle the cursor until the last of the record.
e) Finally, submit the modifications of all records.

2) Access to Stored Procedure of the Host Switch Status

Use to obtain of the switch status of the host, main steps are as follow:
a) Create a database cursor and host type of switch record can be filtered out from the switch object table.
b) Start to circulate the record of the cursor.
c) Initialize parameters.
d) Calculate the totals of alarm record of which the status is not recovered and switch ID is equal to the host switch ID of the current cursor record number. Calculate the totals of the switch object table of which the parent of the element number is equal to the current cursor record number of the host switch and also the totals of subset record with the alarm status of alarm.
e) Determine whether both total alarm records number and total sub-switch record number are zero. If both are zero, set alarm status of the host switch with the non-alarm of which the same switch object table number is equal to the current cursor record.
f) Or else, set the alarm status with alarm.
g) Continue to circulate the record of the cursor until the last record.
h) Finally, submit modifications of all records.

Create stored procedures to access to the process's switch status and the host's switch status in the database to access or set state values of the switch status of process and host. Main steps of the processing for these two stored procedures are: firstly, data indexing and data filtering treatment from the switch interface tables. After filtering out the data, making judgments logically to obtain the status of switch, and then update the status value to the state field in the relevant records from the switch object table.

Stored Procedure Timer-Triggered Scheduled by Regular Tasks

With this regular tasks implementing functions, create a time-set mission in the database, set the tasks that have already been set before in the stored procedures and also set the time interval between the tasks implementation and then the targeted tasks will be implemented as expected and then the switch status polling enquiry is available.

Manually edit the switch type in the switch status interface table. It is used to define types of switch type ID, switch type name, the switch CLASS_ID field means switch type ID. The value is 1 means the host type. Except ALARM_STATE field which is set by the stored procedure in the switch object table, the other fields are automatically reported by the application procedure, in the switch object table, field ALARM_STATE says the alarm state, when its value is 1, it means it has alarm. If it is 0, that means no alarm of the switch, WORK_STATE field in the switch object table says the work status of switch, and reported directly by the application procedure, when the value is 1, it means the switch is running, if 0, it indicates that the switch has ceased running. All fields are automatically reported by network target in alarm information tables except the field CANCEL_BY that means recovery and field CANCEL_TIME means recovery time. Switch ID number field NE_ID in the alarm information table is linked to the switch NE_ID in the switch object table, through field the switch number, it can indexed out that what switch ID is a alarm record belonging to.

The steps of obtaining the switch status stored procedure are as shown below.

Firstly, create database cursor named “CR” from the Switch object table, filter out the records that class_id field value is not equal to 1 and ENABLE field value equal to 1 and then name the record with “C1”, then begin the cycle of the data record. Initialize the variable “recnum” 0, and variable “v_neid” current cursor number that is “C1.NE_ID”, Stat alarm records of which field cancel_by value is −9, and at the same time field NE_ID value is the equal to “v_neid” value and then to give the total number of “recnum”, to judge whether “recnum” is zero, If zero, set NE_ID and “v_neid” the same switch alarm_state; if “recnum” is non-zero, set the switch alarm_state field value with 1. Finally to judge whether the current cursor record is the last, if not continue to cycle, if the current cursor record is the last record, then the terminate the cycle and submit modifications of all records.

The steps to obtain the host switch status stored procedure are as follows.

Create database cursor named “CR” from the Switch object table firstly. Filter out the records that class_id field value is not equal to 1 and ENABLE field value equal to 1 and then name the record with “C1”, then begin the cycle of the data record. Initialize the variable “recnum” 0, and variable “v_neid” current cursor number that is “C1.NE_ID”, Stat alarm records of which field cancel_by value is −9, and at the same time field NE_ID value is the equal to “v_neid” value and then to give the total number of “recnum”, to judge whether “recnum” is zero, If zero, set NE_ID and “v_neid” the same switch alarm state; if “recnum” is non-zero, set the switch alarm_state field value with 1. Finally to judge whether the current cursor record is the last, if not continue to cycle, if the current cursor record is the last record, then terminate the cycle and submit modifications of all records.

Advantages and Characteristics

The traditional polling method of switch status is running on application servers. The system resources of the application servers are occupied. When the number of switch and alarms are more than 3000 and also the number of user requests are more than 30, in a polling cycle, more than 30% of system resources are occupied by the application server, the newly invented method runs on the database server, which has made full use of the database server data processing efficiency and the ability to balance system resources, so for this new method, the application server's occupancy rate of system resources is 0, so that application servers system resources can be used more for other key tasks.

For traditional switch status polling method, each module or each user's session when scheduling easily lead to duplication of switch status query operation, while the newly invented method is to unify the various switch scheduling process stored in the database, in one enquiry cycle, only1 time implementation is done without any additional repetitive operations. What's more, when the switch status query rule or process changes, the polling process needs to be amended or re-compiled, and then to be published to the application server by traditional switch status polling method. In order to make amendments of switch status query procedure be effective immediately, the application server also needs to be restarted which will result in the interruptions of user applications. For this newly invented method when rules or processes change, only need to do modifications to the stored procedure or regularly schedule the implementation of tasks while being recompiled but no need to restart the server.

In a word, the application of this invention is very useful to improve the implementation efficiency of state polling and also beneficial for the maintenance and extension of the switch enquiry procedure.

### BRIEF DESCRIPTION OF THE DRAWINGS

FIG. 1 shows “Access to the process of switch status” stored procedure of the flow chart

FIG. 2 “Access to the host switch status” stored procedure flow chart

### DETAILED DESCRIPTION OF THE INVENTION

The following is the detailed explanation of the invention illustrated with the attached figures and examples.

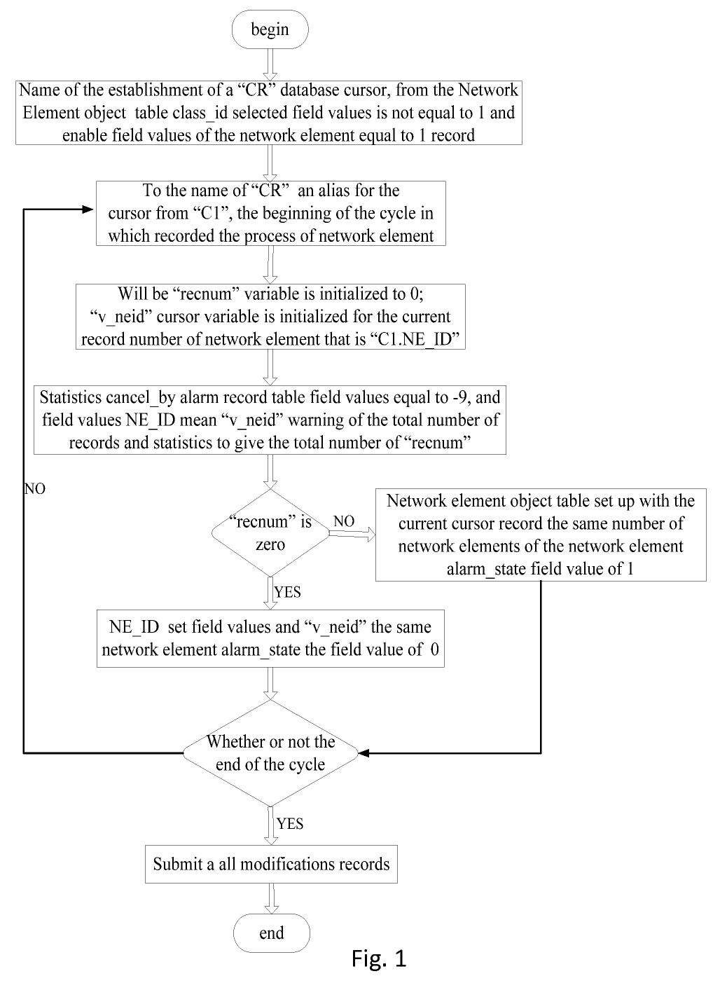

Refer to FIG. 1

Access to the Process of Stored Procedure's Switch Status

As shown in FIG. 1, the steps of accessing to the process of switch status are as follows:
a) Create a database cursor named “CR”, filter out the selected application procedure from the Switch object table (class_id field value is not equal to 1) and also switch records must be effective (ENABLE field value equals to 1)
b) Renamed “CR” database cursor as “C1”, then start cycling the data records;
c) Initialize variables, “recnum” is used to store the total number of alarm record of which its initialized value is 0, “v_neid” initialized value for switch number that the current cursor records is “C1.NE_ID”
d) Restoration status in statistics alarm record table records the total alarm record (cancel_by field value of −9 means that the alarm did not restore) and switch ID is equal to the total number of alarm records to the current cursor record number (NE_ID field value of “v_neid”);
e) Determine whether the total number of alarms (i.e., “recnum”) is zero, if zero then set the same value in the Switch object table as the switch NO with non-alarm status that current cursor records (NE_ID field value is equal to the value of “v_neid”) (that is, alarm_state field value is set to 0)
f) If the total number of alarm records (that is, “recnum”) is not zero, then set the alarm status with alarm (that is, alarm_state field values set to 1);
g) Finally, if the current cursor record is the last record, then terminate the cycle and to submit all modified records, or else it will continue cycle.

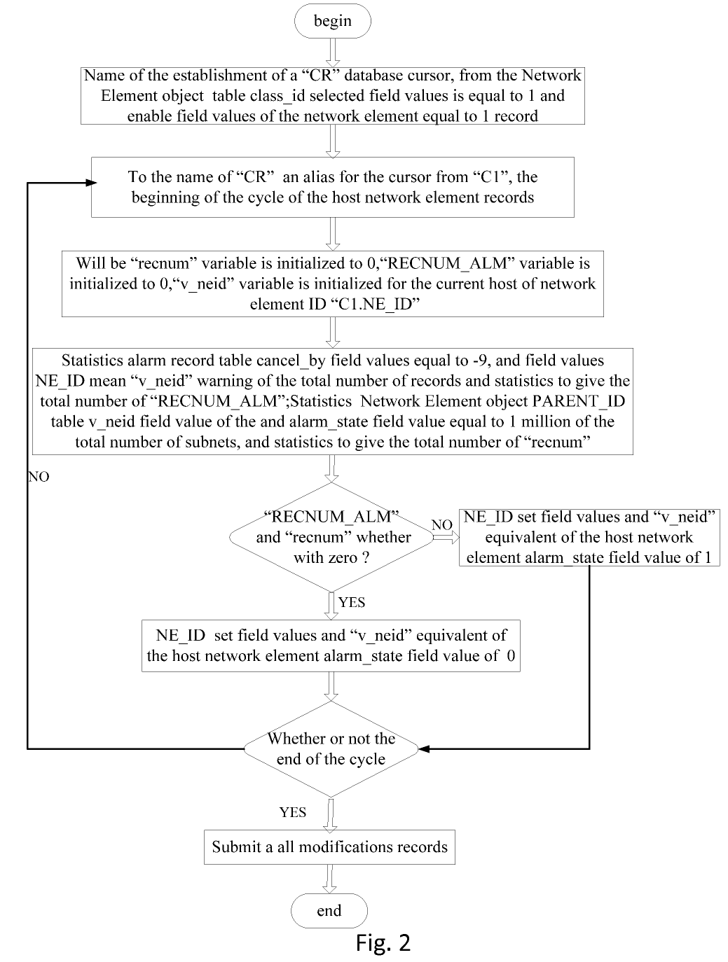

Refer to FIG. 2

Access to Stored Procedure of the Host's Switch Status

As shown in FIG. 2, obtain the status of the host switch as follows:
a) Create a database cursor named “CR”, filter out the selected type of host from the Switch object table (class_id field values equal to 1) and also effective records (ENABLE field values equal to 1).
b) Renamed the “CR” database cursor with “C1”, and start the cycle of the host switch records.
c) Initialize variables, “recnum” is used to store the total alarm records of the switch but belonging to the host switch. The initialized value is 0, “RECNUM_ALM” alarm is used for the storage of total number of alarm records, initialized value is 0; “v_neid” initialized value of the cycle of the host switch that is “C1.NE_ID”.
d) Restoration status in statistics alarm record table is noted as not restored (cancel_by field value −9 means that the alarm did not restore) and switch ID is equal to the total number of alarm records of the current cursor records(NE_ID field value of “v_neid”) and then statistics will show the total numbers of “recnum”. In the Statistics Switch object table, the parent switch ID is equal to the current cursor record number of the host switch (PARENT_ID field values v_neid), and a subset of switch the total number with alarm status alarm (alarm_state field values 1) and then statistics gives the total number of “recnum”.
e) Determine whether the total number of alarm records of Host switch (that is, “RECNUM_ALM”) and the total number of records of alarm status for host subnet (that is, “recnum”) are all zero, if zero then set the host switch state of the alarm with no alarming(that is, alarm_state field value set to 0) for those with switch ID number in the object table equal to the switch ID number that current cursor records (NE_ID field value “v_neid”).
f) If either of “RECNUM_ALM” or “recnum” is a non-zero, then set the Switch object table with the current cursor record the same number of switches (NE_ID field value of “v_neid”) element of the host state for the alarm (that is, alarm_state field values set to 1).
g) Determine whether the current cursor record is the last record or not, if not continue the cycle.
h) Determine whether the current cursor record is the last record or not, if yes, then terminate the cycle and submit all modifications records.

Relevant Interface Table of Switch Status

Create switch object table, switch type table and alarm information table in the database, the field is structured as follows

switch object table

| Field name | Field definition | Type | Null |
|---|---|---|---|
| NE_ID (primary key) | Switch object ID | VARCHAR2(50) | NOT |
| | | | NULL |
| AREA_ID (index) | Area Code | NUMBER(6) | NOT |
| | | | NULL |
| OBJ_NAME | Switch object | VARCHAR2(40) | NOT |
| | Name | | NULL |
| CLASS_ID | Switch type ID | NUMBER(8) | NOT |
| | | | NULL |
| PARENT_ID | Father of Switch | VARCHAR2(50) | NOT |
| | Class No | | NULL |
| ALARM_STATE | Switch alarms | NUMBER(3) | NULL |
| | status | | |
| WORK_STATE | Switch working | NUMBER(3) | NULL |
| | status | | |
| ENABLE | Switch validity | NUMBER(1) | NOT |
| | | | NULL |

All fields can be automatically and directly reported or manually edited by using the application procedure except ALARM_STATE that is set by the stored procedure. ALARM_STATE field stands for alarm status of switch, it status is set by switch from the stored procedure. When its value is 1, means switch alarm, otherwise the switch does not alarm. WORK_STATE field stands for switch working status, the status will be automatically reported by the application procedure progress. When its value is 1, means switch is working, or else switch does not work. CLASS_ID field corresponds to class number in switch type table which can be indexed through this field to index out the types of switch.

Switch type table

| Field name | Field definition | Type | Null |
|---|---|---|---|
| CLASS_ID (primary | switch type ID | NUMBER(8) | NOT |
| key) | | | NULL |
| CLASS_NAME | switch type | VARCHAR2(40) | NOT |
| | name | | NULL |
| FLOW_STEP_ID | switch process | NUMBER(3) | NOT |
| | ID | | NULL |

Switch type table is manually edited and used to define the specific parameters of the type of information, such as the switch type ID, name and etc.

Alarm information table

| Field name | Field meaning | Type | Null |
|---|---|---|---|
| NE_ID | Switch ID | VARCHAR2(50) | NOT |
| | | | NULL |
| CLASS_ID | switch type | NUMBER(8) | NOT |
| | ID | | NULL |
| ALARM_TYPE_ID | Fault | NUMBER(16) | NOT |
| | category | | NULL |
| | code | | |
| ALARM_TIME | Alarm time | DATE | NULL |
| ALARM_TEXT | Alarm details | VARCHAR2(255) | NULL |
| CANCEL_BY | Alarm | NUMBER(8) | NULL |
| | nullifier | | |
| CANCEL_TIME | alarm | DATE | NULL |
| | cancellation | | |
| | time | | |

All fields are automatically reported by switch object except CANCEL_BY and CANCEL_TIME in the alarm information table. NE_ID corresponds to the switch NO. (NE_ID) in switch object table and it can be indexed through this to find out which switch that the alarming message is belonging to. CLASS_ID corresponds to the switch number in switch type table and it can be indexed through this to find out which switch that the alarming message is belonging to. Acquire switch status and set the state value of the stored procedure.

1. By Scheduling Regular Tasks of Stored Procedure

First of all, create a script from a regular schedule to carry out its mandate, its structure is as follows

```
DECLARE
  X NUMBER;
BEGIN
  SYS.DBMS_JOB.SUBMIT
  ( job => X
    ,what => ‘get_neobj_status( ); get_host_status( );’
    ,next_date => to_date(‘08-11-2008 10:33:28’,‘dd/mm/
    yyyy hh24:mi:ss’)
    ,interval => ‘SYSDATE+10/(24*60*60)’ );
COMMIT; END; /
```

X is automatically generated by the database system ID of the task, get_neobj_status ( ) get_host_status ( ) is the stored procedure which needs o be executed and is used to acquire and set switch status. next_date set the next execution time, that is, the success of this mission script compiler will set the time in the beginning of the implementation of automatic timing, this is at 10:33 on Nov. 8, 2008: 28, interval set the time interval, that is, how often a stored procedure will be executed, this is once every 10 seconds; later on, execute the above-mentioned script, the database system will automatically start from the Nov. 8, 2008 10:33:28, and periodically execute two stored processes which is used for acquiring and setting process and host switch statue—i.e., get_neobj_status ( ) and get_host_status ( ) every 10 seconds in order to achieve the polling of switch status.

The switch type form in the relevant switch status interface table is manually edited and used to define switch type ID, switch type name. And in the switch type table, CLASS_ID field means the type ID of the switch, when its value is 1, that means the host type. In the Switch object table ALARM_STATE fields in addition to setting up by the stored procedure, the remaining field is automatically reported by the application procedure, in the switch object table, ALARM_STATE field shows the alarm status. It is the state of switch from the stored procedure that decides the status value. When its value is 1, it shows the alarm. If it is 0, that means no alarm of the switch. Switch WORK_STATE field shows the working status of switch, and reported directly by the application procedure. When its value is 1, it means that switch is running. If 0, it indicates that the switch has ceased running.

In the Alarm message table, except for the fields recovery CANCEL_BY and recovery time CANCEL_TIME field, the remaining fields are automatically reported by switch target. And also field switch NE_ID in the alarm message table is related with switch (NE_ID) field in the switch object table. Through indexing the field switch ID, an alarm message can be indexed out, indicating which switch it belongs to

What is claimed is:

1. A polling method of switch status based on Timer-triggered Scheduler of Stored Procedures is to create a lot of interface table related with switch status in the database including object tables, the switch type table, switch alarms table and network information table used to store meta-information and switch status values; then create stored procedure of acquiring the corresponding switch status for all types of switch needed for polling of switch status; the corresponding stored procedure will filter out data and determine the switch status, and then write the corresponding state value into switch status interface table; finally create regularly-executed tasks for timer-triggered scheduler of stored procedures, including the establishment of the relevant switch status interface table; access to switch status and set the stored procedure of the status value; and stored procedure will be dispatched by regularly-executed tasks:
1) Create the related switch state interface table:
state of the relevant switch interface is a set of tables in the database to establish the state of switch and storage-related data tables for storing switch status information, including the switch object table, switch type table and alarm information table;
switch object table: used to store the basic switch information and status information, the main fields, including “switch object code”, “area codes”, “switch object name”, “switch type code”, “father switch ID “, “the state of switch alarms” and “ switch working status”;
switch type tables are shown as follow: used to store information about switch type to distinguish which types each switch is belonging to in switch object table, its main fields including “switch type code”, “switch type name” and “switch part of their process ID”;
alarm information table: used to store all switch alarm information in switch object table, the main field including “switch ID”, “switch type code”, “fault-type number”, “alarm details”, “ alarm canceled” and “ alarm cancellation time”;
create switch object table, switch types table, alert network information table in the database which are used to store meta-information and state information among which the switch number basic information and related warning information can be indexed using the switch type ID and the type of switch can be distinguished whether belonging to the host or the type of the process;
2) access switch status and set the state value of the stored procedure
the function is to be realized through a group of SQL statements programmed to access switch status and finish the storage function of its state value and through controlling the implementation of these SQL statements and then making judgment logically; this set of SQL statements, and logic judgment program used to control the execution flow of these SQL statements are called stored procedure in BD technology; these stored procedures can be stored in the database after being compiled; users can specify the name of stored procedure and then once parameters are given, the procedure is to be implemented, compiling only needed while creating a stored procedures, afterwards, there is no need to re-compile when stored procedure is executed each time; stored procedure of accessing to switch status of process is used to access to the status of application program switch; its steps are shown as below:
a) create a database cursor from network object table and filter out the application type switch record;
b) start circulate the cursor records;
c) initialize parameters;
d) calculate the records with un-covered status from alarm record table, and of which the switch ID is equal to the current cursor record number;
e) determine whether the total number of alarm records is zero; if it is zero, set the alarm state with the non-alarm;
f) or else, set alarm to the switch to which the current cursor recorded switch ID is equal in switch object table;
g) continue cycle the cursor until the last of the record;
h) finally, submit the modifications of all records;
access to stored procedure of the host switch status is used to obtain the host of the switch status, main steps are shown as follow:
a) create a database cursor, and from the switch object table, filter out host-type switch record;
b) start to circulate the record of the cursor;
c) initialize parameters;
d) calculate the totals of alarm record of which the status is not recovered and switch ID is equal to the host switch ID of the current cursor record number; Calculate the totals of the switch object table of which the parent of the element number is equal to the current cursor record number of the host switch and also the totals of subset record with the alarm status of alarm;
e) determine whether both total alarm records number and total sub-switch record number are zero; if it is both zero, set alarm status of the host switch with the non-alarm of which the same switch object table number is equal to the current cursor record;
f) or else, set the alarm status with alarm;
g) continue to circulate the record of the cursor until the last record;
h) finally, submit modifications of all records; create stored procedures to access to the process's switch status and the host's switch status in the database to access or set state values of the switch status of process and host; main steps of the processing for these two stored procedures are: firstly, data indexing and data filtering treatment from the switch interface tables; after filtering out the data, making judgments logically to obtain the status switch, and then update the status value to the state field in the relevant records from the switch object table;
3) stored procedure timer-triggered scheduled by regular tasks use regularly-executed task function in the database to establish a regularly-executed task; set those procedures mentioned above to the tasks need to be executed, i.e., formerly-established stored procedures of accessing to switch status and host switch status;
then set a interval to execute this task, which can achieve the purpose of regularly inquiring switch status so that polling of switch status can be realized.

2. The polling method of switch status based on Timer-triggered Scheduler of Stored Procedures of claim 1, wherein by the manually edit of switch type table in the switch status interface tables, and it is used to define the switch type ID, type name of switch; CLASS_ID field means the switch types number, when its value is 1, it means the host type;
except ALARM_STATE field which is set by the stored procedure in the switch object table, the other fields are automatically reported by the application procedure, in the switch object table, field ALARM_STATE says the alarm state, when its value is 1, it means it has alarm; if it is 0, that means no alarm of the switch, WORK_STATE field in the switch object table says the work status of switch, and reported directly by the application procedure, when the value is 1, it means the switch is running, if 0, it indicates that the switch has ceased running; all fields are automatically reported by network target in alarm information tables except the field CANCEL_BY that means recovery and field CANCEL_TIME means recovery time; switch ID number field NE_ID in the alarm information table is correspondent with the switch NE_ID in the switch object table, through field the switch number, it can indexed out that what switch ID a alarm record is belonging to.

3. The polling method of switch status based on Timer-triggered Scheduler of Stored Procedures of claim 1, wherein to access to the process of switch status stored procedure and steps are: to establish a database cursor named “CR”, select records of which field class_id value is not equal to 1 and field ENABLE value equal to 1 from the Switch object table; name the cursor “CR” an alias as “C1”, start the cycle of the data record and initialize “recnum” variable 0 and “v_neid” variable i.e. current cursor number of switch that is “C1.NE_ID”; calculate the alarm records of which the field “cancel_by” value is −9 and the field NE_ID value is “v_neid”; and then give the total number to “recnum” and at the same time to inquire whether the value is Zero, if zero then set the field alarm_state of which the NE_ID value is equal to “v_neid” value to Zero; if “recnum” is non-zero, then set the field alarm_state to 1; at last, to decide whether the current cursor is the last record or not, if not, continue to cycle, if yes, then terminate the cycle and submit all modifications records.

4. The polling method of switch status based on Timer-triggered Scheduler of Stored Procedures of claim 1, wherein to access to the process of host switch status stored procedure and steps are: to establish a database cursor named “CR”, select records of which field class_id value is not equal to 1 and field ENABLE value equal to 1 from the Switch object table; name the cursor “CR” an alias as “C1”, start the cycle of the data record and initialize “recnum” variable 0 and “v_neid” variable i.e. current cursor number of switch that is “C1.NE_ID”; calculate the alarm records of which the field “cancel_by” value is −9 and the field NE_ID value is “v_neid”; and then give the total number to “recnum” and at the same time to inquire whether the value is Zero, if zero then set the field alarm_state of which the NE_ID value is equal to “v_neid” value zero; if “recnum” is non-zero, then set the field alarm_state to 1; at last, to decide whether the current cursor is the last record or not, if not, continue to cycle, or else, terminate the cycle and submit all modifications records.
